(19) United States
(12) Patent Application Publication
(10) Pub. No.: US 2002/0184135 A1
(43) Pub. Date: Dec. 5, 2002

(54) Computer-implemented equipment brokering method and system

(75) Inventor: Adel A. Zakaria, Moline, IL (US)

Correspondence Address: Charles T. Graham, Patent Department, DEERE & COMPANY, One john Deere Place, Moline, IL, 61265-8098, US

(73) Assignee: Deere & Company, a Delaware corporation

(21) Appl. No.: 09/867,356

(22) Filed: May 29, 2001

(51) Int. Cl. G06F 17/60

(52) U.S. Cl. 705/37

(57) ABSTRACT

A computer-implemented system and method for matching buyers with sellers in order to sell used equipment. An used equipment matching database engine receives selling criteria data from a seller. An used equipment brokering database is connected to the used equipment matching database engine in order to store the selling criteria data. The used equipment matching database engine receives bid criteria data from a buyer, wherein the bid criteria data does not satisfy the selling criteria data. A value adding module connected to the equipment matching engine determines and adds value from a third party (e.g., a broker) so as to substantially make the bid criteria data satisfy the selling criteria data.

### BACKGROUND OF THE INVENTION

1. Field of the Invention

The present invention relates generally to computer systems that handle used equipment procurement, and more particularly, to computer systems for brokering deals involving used equipment.

2. Background and Summary of the Invention

Currently, a purchaser of used equipment, such as agricultural or construction machinery, is limited to selecting equipment off the lot of a local equipment dealer. If a purchaser is willing to travel a distance and has the means or money to pay for transporting the equipment, he can visit a number of different dealers and increase the selection from which to choose. The use of the Internet has broadened the search capabilities but at an increased transportation cost. A disadvantage to buying through the Internet is the inability to actually see and “test drive” the equipment before purchasing.

When buying used equipment off a dealer's lot, the buyer pays the dealer more than the dealer paid to the seller of the equipment or more than the dealer gave as credit for the trade-in when the seller bought a new piece of equipment. This difference in price compensates the dealer for carrying the used equipment inventory. However, if the dealer cost were eliminated from the transaction, the seller would be able to net more from the sale and the buyer would be able to get the equipment at a lower cost. The sale and purchase prices would be closer to the true value of the machine as the market operates more efficiently.

In accordance with the teachings of the present invention, a computer-implemented system and method are provided for matching buyers with sellers in order to sell used equipment directly without the vehicle being carried as inventory by the dealer. An used equipment matching database engine receives selling criteria data from a seller. An used equipment brokering database is connected to the used equipment matching database engine in order to store the used equipment selling criteria data. The used equipment matching database engine receives bid criteria data from a buyer. A broker, such as an equipment dealer or manufacturer, or both working together, step into the transaction when a match is found The broker provides services including vehicle inspection, reconditioning, extended warranty, etc. to allay the buyer's concerns about the condition of the equipment. Although the buyer's bid criteria (such as the buyer's bid price) may be determined to be less than the asking criteria (e.g., selling price) for the seller's used equipment, a value adding software module determines and adds value from a third party (e.g., the broker) to substantially satisfy the seller and the buyer. The added value may be additional cash to compensate for the lower bid price, equipment inspection, equipment reconditioning, an extended warranty, transportation of the equipment from the seller to the buyer, etc. The broker provides the added value in hope of selling new equipment to the seller of the used equipment. The degree to which value is added may change with market conditions and the need to stimulate the market.

The present invention is useful with all types of used equipment such as, but not limited to, agricultural machinery, construction machinery, forestry equipment, lawn and turf care equipment, motor vehicles, machine tools, mining equipment, etc.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the software-implemented components used to obtain used equipment;

FIGS. 2 and 3 are data structure diagrams depicting the structure of the used equipment brokering database;

FIGS. 4 and 5 are flowcharts depicting the steps used to capture equipment information from an owner/seller of used equipment;

FIG. 6 is a flowchart depicting the steps used to capture equipment information from a dealer of used equipment;

FIG. 7 is a flowchart depicting the steps used to update the used equipment brokering database from a location where the equipment is in operation; and

FIGS. 8-11 are flowcharts depicting the steps used to determine what value is to be added to transactions between buyers and sellers of the used equipment.

### DETAILED DESCRIPTION OF THE PREFERRED EMBODIMENT

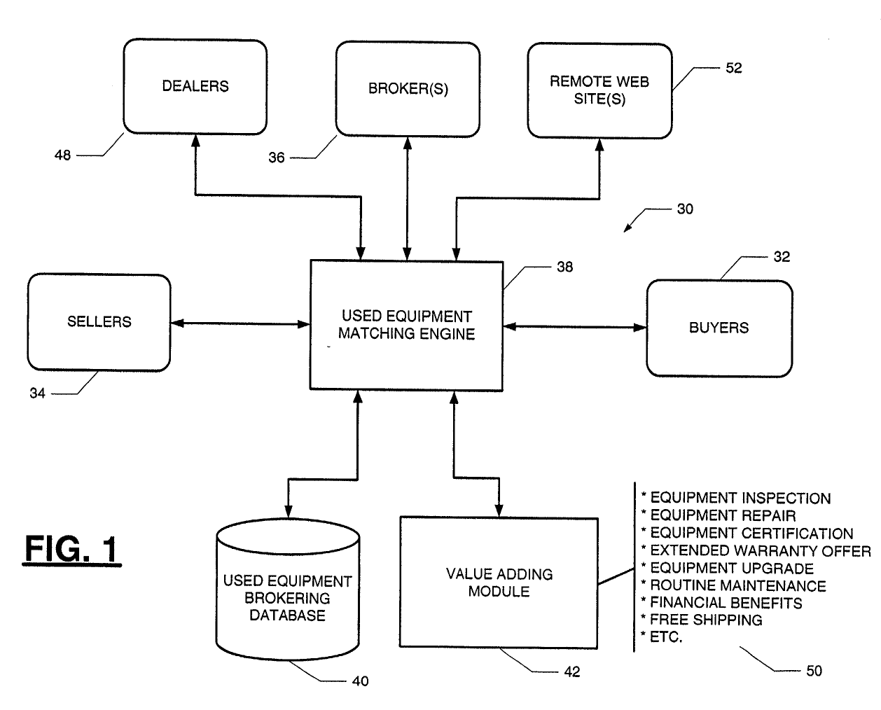

FIG. 1 depicts a system 30 that matches buyers 32 with equipment sellers 34. System 30 allows transactions to occur that ordinarily would not occur due to a significant difference existing between what the buyers 32 are willing to pay for used equipment and the price at which sellers 34 are willing to sell. System 30 bridges this difference by providing software components that determine and add value from a third party to the transaction.

System 30 provides an equipment matching engine 38 to act as an interface between buyers 32 and sellers 34. The equipment matching engine 38 utilizes an used equipment brokering database 40 and a value adding software module 42 to provide and retrieve transactional information for the parties and to determine what value can be added to the transaction in order to bridge the price difference between the seller and the buyer. System 30 also utilizes brokers 36 to facilitate the transaction, such as by reviewing the value that has been recommended by the value adding module 42. The broker's review may result in adjusting the recommended value to better fit the situation at hand.

When a seller 34 initially buys a piece of equipment, new or used, from a dealer, the seller 34 is asked to specify a price at which the seller 34 would be willing to sell. The price together with information identifying the equipment (such as, make, model, year, hours, condition, optional equipment, etc.) are stored in the used equipment brokering database 40 as selling criteria data. The information is updated in the used equipment brokering database 40 by periodic input by the sellers 34.

Sellers 34 may not be actively selling their equipment but may be willing to sell if the right price were offered. System 30 may also be used by those who are actively looking to sell.

The selling dealers 48 may also input the vehicle information. Additionally, the dealers 48 typically have access to information about equipment due to their servicing of the equipment. For example, the dealer 48 may enter equipment information whenever the equipment is being serviced, either at the request of the seller 34 or through a preventative maintenance agreement. Equipment information may also be updated in the database 40 by a wireless communication system from the equipment to a central place that is used to monitor the equipment's operational condition. Alternatively, the seller 34 may add equipment information to the database 40 at any time if it is not already in the database 40.

A buyer 32 looking for used equipment enters as bid criteria data the buyer's equipment needs by specific model number or by the type of equipment and size. The buyer 32 may also supplement the bid criteria data with a number of other search criteria, such as equipment condition, age, hours, options, and price (or a price range within which the buyer 32 is willing to pay). Location may be one of the search criteria. Various search items may also have a deviation factor for making a match. A deviation example includes returning as matches equipment whose model years are within one year from the requested model year. These may be determined by the buyer 32 or set by default.

The equipment matching engine 38 uses the buyer's search criteria to search the used equipment brokering database 40. The equipment matching engine 38 not only returns exact matches (if they exist) based upon the buyer's search criteria, but also candidate matches that, while they do not exactly match the buyer's search criteria, may still form the basis of a transaction due to value being added by the value adding module 42.

The value adding module 42 compares the information from the buyer 32 with the equipment information from the sellers 34 to determine what equipment may be suitable with the addition of value from a third party to form a transaction. The third party may be an equipment dealer or manufacturer or both. For example, buyer 32 may have specified that the buyer's location is in the state of Idaho and to keep transportation costs at a minimum, has specified that the buyer 32 only wants equipment located in Idaho. The equipment matching engine 38 searches the used equipment brokering database 40 in order to locate the equipment within the state of Idaho. The equipment matching engine 38 also retrieves the desired equipment that is located in other states and allows the value adding module 42 to determine whether it is cost effective to provide free or reduced price transportation of equipment from the remote state to Idaho. The equipment manufacturer may decide to pay for the transportation in order to have the opportunity to provide the seller with new equipment.

The value adding module may interact with remote web sites 52 to obtain the best price to ship the equipment. For example, the value adding module 42 may request from several shipping companies what each company would charge for transporting a specific piece of equipment. The value adding module 42 may provide a range of pickup and delivery dates to allow the shipping companies' web sites 52 to supply a range of shipping prices. The value adding module 42 selects a shipping company to ship the equipment and provides the free shipping to the buyer 32 so that a deal may be formed despite the equipment being located in another state. The interaction between the value adding module 42 and the remote web sites 52 occurs automatically so that the value may be added to the deal in substantially real-time. The present invention also provides for automatic interaction with other types of remote web sites 52, such as financial web sites. This interaction allows the value adding module 42 to automatically obtain the most favorable financial arrangements to the buyer 32.

Another example of added value can occur even when the buyer's bid price is equal to or higher than the seller's asking price but the seller's equipment is not in the condition sought by the buyer. For example, the seller's equipment has more hours than desired by the buyer. In this case value can be added by reconditioning of the machine, an inspection, extended warranty, etc. to make the machine more attractive to the buyer.

To further facilitate the transaction, brokers 36 may step in and contact the buyer 32 and seller 34 to broker a deal. The brokers 36 may gather additional information about the equipment, such as obtaining digital photos and detailed service information (if these are not already present in the used equipment brokering database 40). The brokers 36 are prompted by the equipment matching engine 38 when certain key information is missing for equipment requested by buyer 32.

In an effort to create a market, the brokers 36 rely on the value adding module 42 to specify incentives to make up the difference between the asking price and the bid price. Examples of what the value adding module 42 may add to the transaction include those specified by reference numeral 50, such as free or reduced amounts for equipment inspection, equipment repair, equipment certification, extended warranty offer, equipment upgrade, routine maintenance, and shipping. It must be understood that the value adding items listed by reference 50 are not exhaustive and include other types of values useful to the deal. For example, the value adding module may provide financial benefits, such as adding cash from a third party (e.g. a dealer) to the transaction or a favorable financial loan arrangement that compensates for the difference between the asking price and the bid price. The value adding module 42 may provide one or a combination of the value adding items found in list 50. For example, the value adding module 42 may provide a combination of equipment inspection and free transportation to overcome the difference between the asking price and the bid price. Through the facilitation of the sale, the buyer is now in the market for new equipment. The willingness of brokers 36 to facilitate deals may depend upon market conditions. For example, in a “down” market, brokers are more interested in financially assisting the deal.

Brokers may also step in to negotiate between the buyer and the seller. For example, the seller may be willing to take less than the asking price and the buyer may be willing to pay more than the bid amount. The broker attempts to satisfy both the seller and the buyer.

Various parties may operate as brokers 36. Examples are the equipment manufacturer being a broker or an equipment dealer being the broker. Alternatively, the manufacturer and the dealer may work together as the broker and broker's agent with the manufacturer acting to offer the cash and paying for shipping, warranty, etc. with the local dealer performing the services. Two dealers may be involved, one at the location of the seller to provide information about the equipment and prepare the equipment for shipping and one at the location of the buyer to receive the equipment and perform any set-up following shipment. Brokers 36 may manually intervene in the present invention and be requested by the value adding module 42 to specify what value adding item(s) should be used for a particular deal or for deals in general.

The system 30 may be implemented within an world wide web Internet-based structure where buyers 32, sellers 34, and brokers 36 communicate with the equipment matching engine 38 over the Internet network. In this sense, the parties use client computers (e.g., personal computers) to access a remote server computer that operates the equipment matching engine 38. The used equipment brokering database 40 and the value adding module 42 may reside on the same server computer as the equipment matching engine 38, or may be in data communication with the equipment matching engine 38 while on other networked computers.

The equipment matching engine 38 does not require sellers 34 to specify a selling price for their equipment. The sellers 34 could list as a default price the current “blue book” (market value) price for the equipment. This results in an advantage that as the equipment ages, the selling price automatically changes in the database 40 without the need for the sellers 34 to repeatedly update their asking prices. Also, this allows the equipment to automatically reflect a truer market value for the equipment without the sellers 34 having to perform detailed research for determining a realistic asking price. The present invention may automatically retrieve current market values from remote web sites 52. The equipment matching engine 38 sends sufficient equipment information so that the remote web sites 52 may provide current market value appraisals. The equipment matching engine 38 may retrieve from several remote web sites 52 market values for a piece of equipment and use an average of the returned values.

The present invention provides an advantage that the owner is not “bothered by lookers”. The sellers 34 are only contacted by brokers 36 (through electronic mail, fax, etc.) when serious, qualified buyers are located. The present invention may also include requiring buyers 32 to pay an up-front fee so that search requests are limited to those who are serious buyers.

The present invention allows sellers to expand their ability to sell their equipment. Buyers benefit from the present invention since they may be able to buy equipment at a lower price. The seller may get more than the seller would have received as a trade-in while the buyer may be able to buy for less than buying off the dealer's used equipment lot. The dealer benefits by not having to carry the used equipment inventory. Because the dealer does not have to carry the used equipment inventory, the transaction cost is reduced. The amount the dealer (or broker) contributes through the value adding module are determined by existing market conditions and the need to stimulate the market. By facilitating the transaction, the seller is now in need of a new machine to replace the one just sold. Thus, the market is stimulated. The present invention further stimulates the market by allowing the present invention to determine that a manufacturer is to provide value to a transaction involving a competitor's piece of used equipment. The manufacturer may offer free transportation in order for the sale of the competitor's piece of equipment to occur. The manufacturer can possibly obtain compensation downstream by selling replacement equipment to the seller.

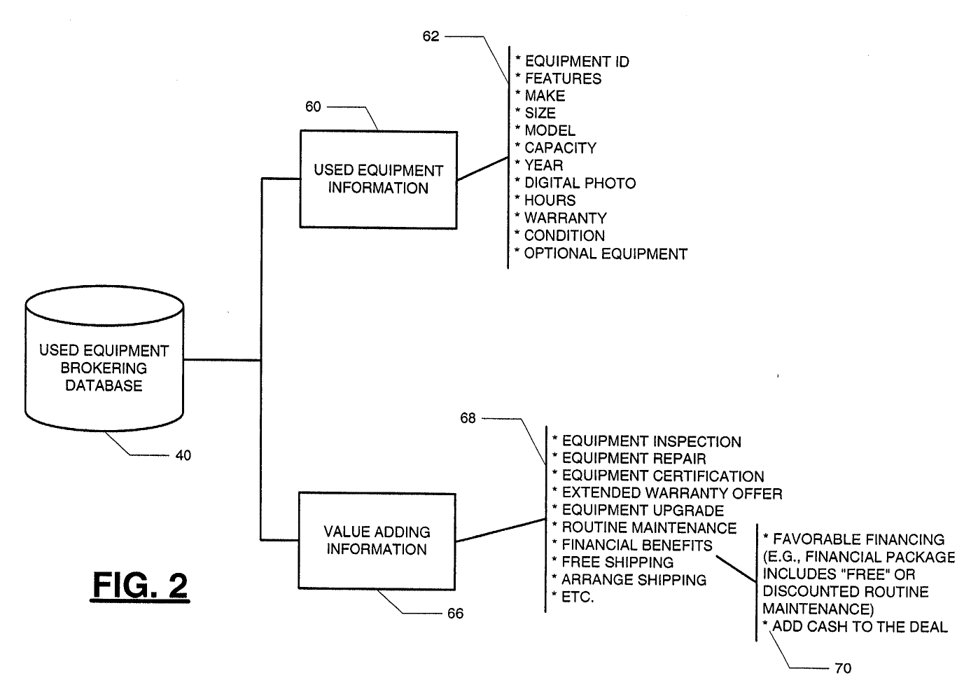

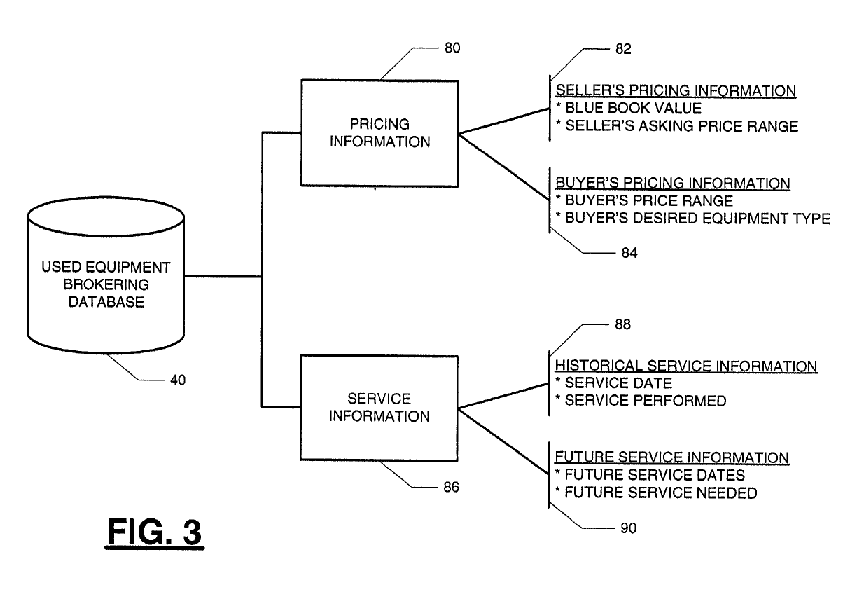

FIGS. 2 and 3 depict an exemplary data structure used for the used equipment brokering database 40. With reference to FIG. 2, the used equipment brokering database 40 stores information in an equipment information data structure 60, value adding data structure 66, pricing information data structure 80, and service information data structure 86. Equipment information data structure 60 typically includes the technical characteristics of the equipment to be sold, of which an exemplary characteristics list is shown by reference numeral 62. The characteristics list may include the make, model, year, etc. of a piece of equipment to be sold. Equipment information data structure 60 may store other information such as the type of warranty a piece of equipment has from the manufacturer and/or dealership.

Value adding data structure 66 stores information about what value adding items are available to make up the difference between the asking price and the bid price. The value adding data structure 66 also includes criteria for when the value adding items should be used. Exemplary value adding items are listed by reference numeral 68, such as offering equipment inspections, extended warranties, or arranging the shipping of the equipment. Additional value-adding items include financial benefits such as those listed by reference numeral 70. For example, the present invention may add cash to the transaction in order to make up the difference between the asking price and the bid price or to provide a very favorable interest rate to finance the deal.

With reference to FIG. 3, the used equipment brokering database 40 also includes pricing information data structure 80. Pricing information data structure 80 contains pricing information 82 obtained from the seller as well as pricing information 84 from the buyer. If the seller does not provide a price for the piece of equipment, then the present invention obtains the “blue book” value of the equipment.

Used equipment brokering database 40 includes service information data structure 86 to store historical and future servicing information about the equipment. Historical service information data structure 88 contains what service has already been performed on a piece of equipment as well as the date the service was performed. Service information data structure 86 may also include what servicing the equipment needs in the future as shown by reference numeral 90. The future service information data structure 90 may be used by the present invention to determine how much value can be added to a transaction by providing future servicing or maintenance for a piece of equipment.

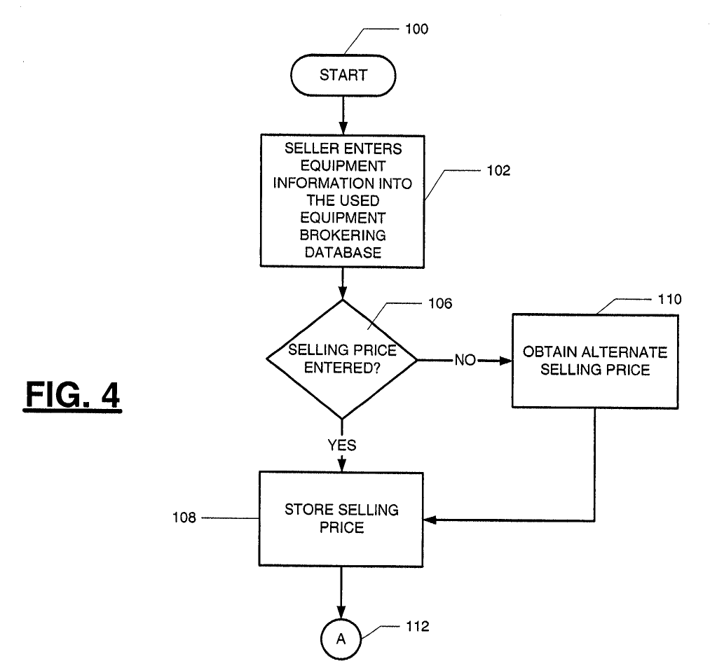

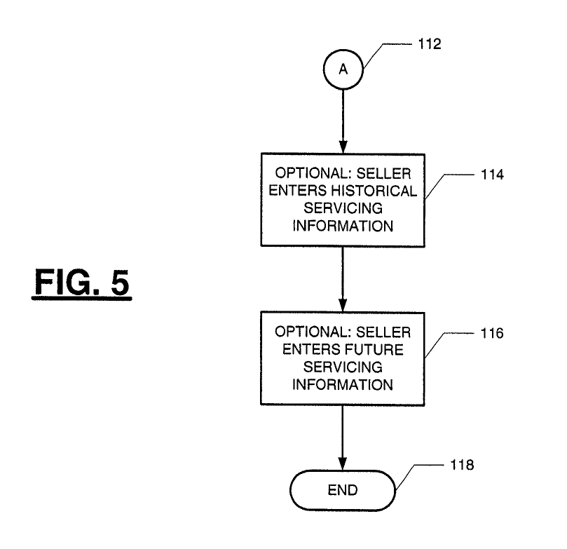

FIGS. 4 and 5 are flowcharts depicting the steps used to obtain information from a seller or owner of equipment. Start block 100 indicates that at process block 102 the seller of the equipment provides equipment information to the used equipment brokering database. Alternatively, the dealer may enter the equipment information.

Decision block 106 examines whether the seller has provided a selling price for the equipment. If the seller has provided a selling price, then process block 108 stores the selling price along with the entered equipment information into the used equipment brokering database. However, if decision block 106 determines that the selling price has not been entered, then process block 110 obtains an alternate selling price. For example, process block 110 may obtain a selling price for the equipment based upon the blue book value of the equipment. Process block 110 may query a remote web site in order to obtain the blue book value. Process block 108 then stores the alternate selling price. Processing continues on FIG. 5 as indicated by continuation block 112.

With reference to FIG. 5, process block 114 prompts the seller to enter historical servicing information related to the equipment. It is noted that the user may choose not to enter the historical servicing information of equipment; however, if the equipment is serviced by a dealer, then the dealer may enter historical and/or future servicing information for the equipment. At process block 116, the seller may elect to enter what future servicing is needed for the equipment. For example, the equipment may require tire replacement after another 1000 hours of operation. The seller may update the equipment information as often as the seller wishes. Processing for the seller-provided equipment information terminates at end block 118.

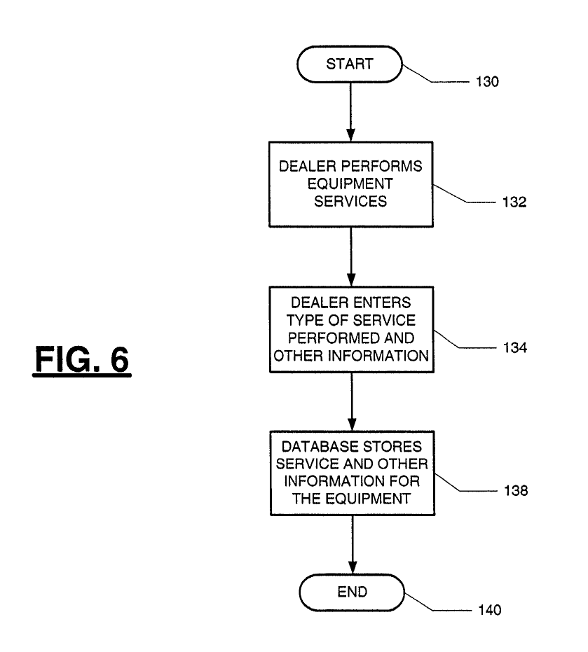

FIG. 6 is a flowchart that depicts the steps used to obtain equipment information from a dealer. Start block 130 indicates that at process block 132, the dealer performs service on the equipment. At process block 134, the dealer enters the type of service performed and other information such as current hours on the machine. At process block 138, the used equipment brokering database stores the service and other information for the equipment before processing terminates at end block 140.

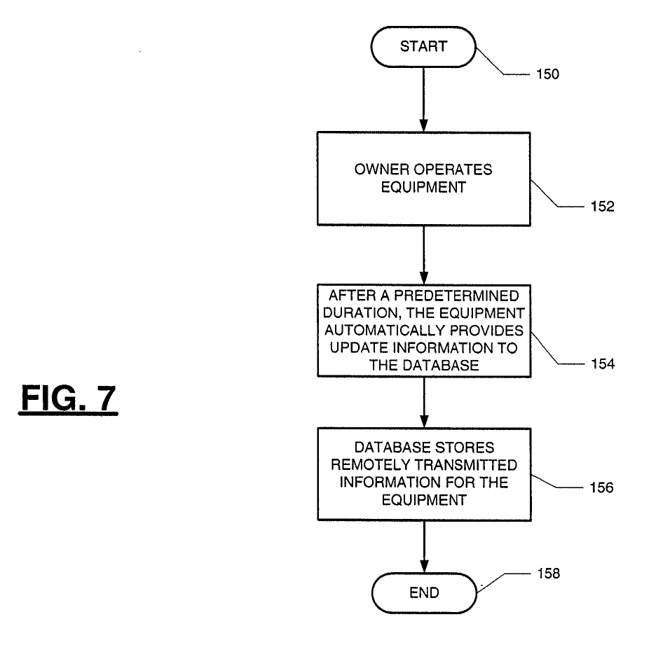

FIG. 7 is a flowchart that depicts the steps used to update the used equipment brokering database from a location where the equipment is in operation. Start block 150 indicates that at process block 152, the owner operates the equipment (such as, using the equipment in an agricultural field). At process block 154, the equipment automatically transmits operational update information which is received by the used equipment brokering database. For example, a tractor may transmit through a wireless communication system the tractor's operational update data to a central location which then provides the information to the used equipment brokering database. The tractor may provide the operational update information at a set interval, such as after every 500 hours of operation. At process block 156, the used equipment brokering database stores the remotely transmitted equipment information. Processing terminates at end block 158.

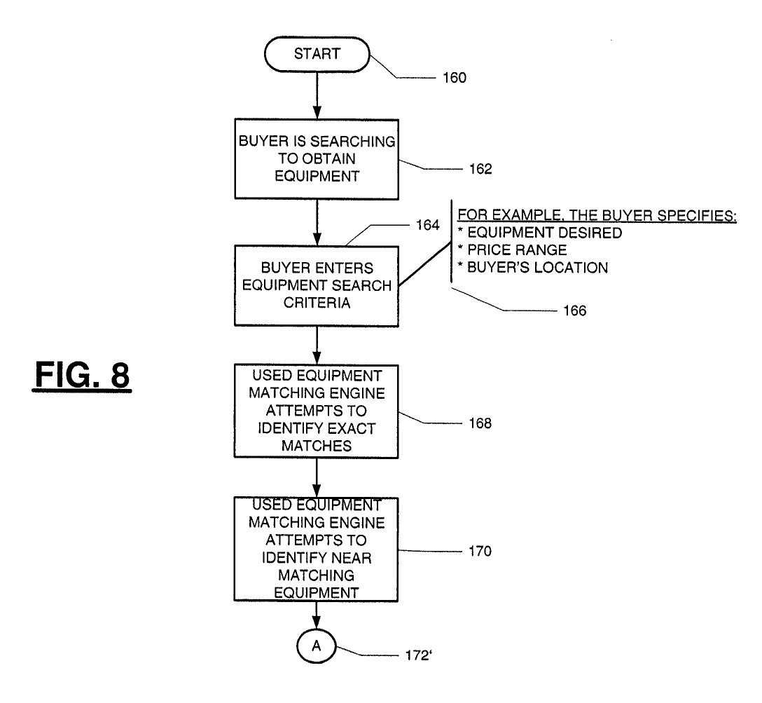

FIGS. 8-11 depict the steps used to determine what value may be added to transactions between buyers and sellers of agricultural equipment. With reference to FIG. 8, start block 160 indicates that at process block 162 a buyer invokes the present invention in order to obtain equipment. At process block 164, the buyer enters equipment search criteria. For example, the buyer may specify the model of the desired equipment as well as a price range as shown by reference numeral 166. The buyer may also specify the buyer's location in order to reduce the overall price of the transaction.

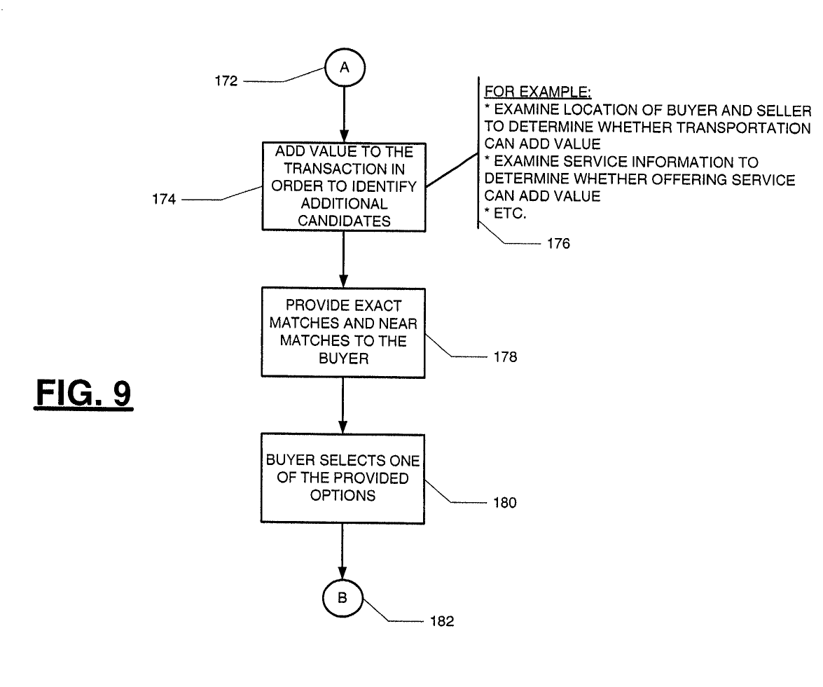

At process block 168, the equipment matching engine attempts to identify exact matches based upon the equipment search criteria. At process block 170, the equipment matching engine also attempts to identify near matching equipment that may not exactly match the buyer's search criteria. Process block 170 identifies near matching equipment by determining what equipment data entries in the database might be used as a basis for the transaction if additional value were provided by a third party to the transaction (it is noted that the database has at least one data entry for a listed piece of equipment). This processing is shown on FIG. 9 at process block 174.

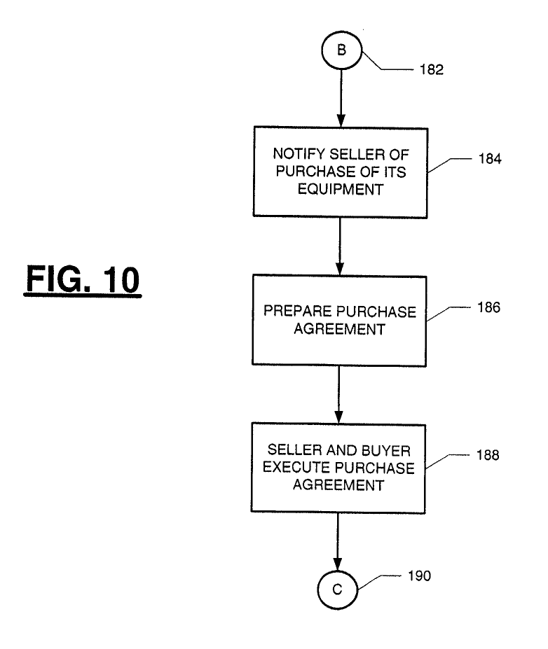

With reference to FIG. 9, process block 174 determines what value may be added to the transaction in order to identify additional candidates. For example, as shown by reference numeral 176, the present invention may examine the locations of the buyer and seller and determine whether free transportation provided by the broker can add enough value to establish a viable transaction. The present invention may also examine other factors such as whether the equipment is close to a routine service date so that the broker may provide the routine service of the equipment for free or at a reduced rate in order to create a viable transaction. Process block 178 provides as transaction options the exact matches and the near matches to the buyer. At process block 180, the buyer selects one of the provided options. The buyer need not be aware of the value added to the transaction by the broker. Processing continues as shown by continuation block 182 on FIG. 10.

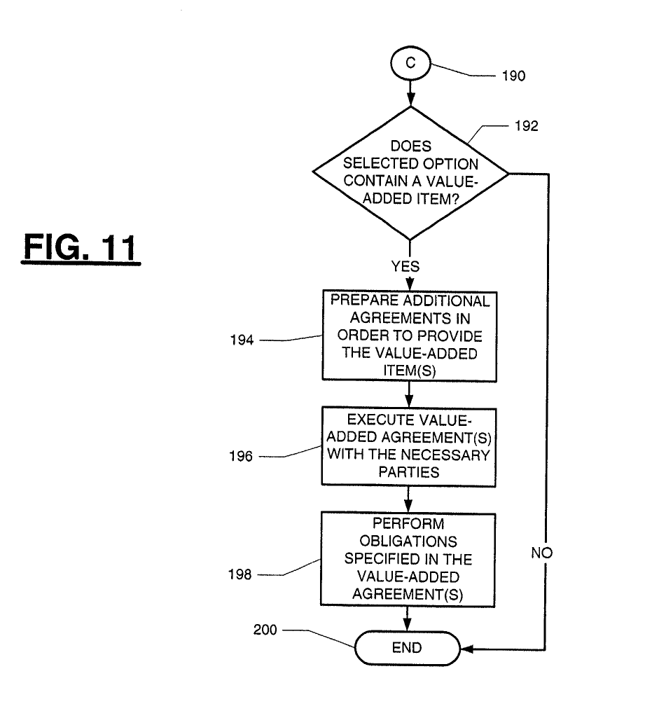

With reference to FIG. 10, process block 184 notifies the seller of the buyer's request. This may be done through a broker once the broker has qualified the buyer to eliminate unnecessary contact of the seller by mere “lookers.” It is noted that the present invention may conduct these transactions without providing the identity of the buyer and the seller, or may disclose their identities after the terms of the transaction have been finalized. At process block 186, the broker prepares the purchase agreement, and the seller and buyer execute the purchase agreement at process block 188. Processing continues as shown by continuation block 190 on FIG. 11.

With reference to FIG. 11, decision block 192 examines whether the selected option by the buyer contains at least one value-added item. If it does not, then processing terminates at end block 200. However, if the buyer has selected an option where the present invention has added value, then process block 194 may prepare additional agreements so that the value-added item(s) may be properly provided. For example, if a value-added item included free transportation of the equipment from the seller to the buyer, then the papers needed to ship the equipment from the seller's location to the buyer's location are generated and sent to the necessary parties (which include the shipping company). The present invention may have an automated Internet interface with one or more shipping companies to automate the generation of shipping papers.

Therefore, if needed, the buyer or dealer/broker and the other necessary parties execute the value-added agreement at process block 196. At process block 198, the obligations specified in the value-added agreement are performed. For example, if the value-added agreement is a shipping agreement, then the shipper performs the obligations specified in the shipping agreement. Processing terminates at end block 200. Through this method, the dealer avoids tying up the dealer's capital in buying used equipment or trade-ins. With less overhead, the seller can retain more of the selling price, and the buyer is able to pay less than they otherwise would have.

The invention being thus described, it will be obvious that the same may be varied in many ways. For example, it should be noted that the present invention is not limited to any particular type of used equipment. The present invention applies to all used equipment such as to agricultural equipment, construction equipment, forestry equipment, lawn and turf care equipment, motor vehicles, machine tools, mining equipment, etc. Such variations are not to be regarded as a departure from the spirit and scope of the invention, and all such modifications as would be obvious to one skilled in the art are intended to be included within the scope of the following claims.

What is claimed is:

1. A computer-implemented system that matches buyers with sellers in order to sell used equipment, comprising:
an used equipment matching database engine that receives selling criteria data from a seller;
an used equipment brokering database connected to the used equipment matching database engine that stores the selling criteria data;
said used equipment matching database engine receiving bid criteria data from a buyer, wherein the bid criteria data does not satisfy the selling criteria data; and
a value adding module connected to the equipment matching engine that determines and adds value from a third party so as to substantially make the bid criteria data satisfy the selling criteria data.

2. The computer-implemented system of claim 1 wherein the value added by the value adding module is not to the financial detriment of the seller of the used equipment.

3. The computer-implemented system of claim 2 wherein the selling criteria data includes an asking price at which the seller will sell the used equipment, wherein the value added by the value adding module does not affect the asking price of the seller.

4. The computer-implemented system of claim 2 wherein the third party is a broker who incurs an immediate financial detriment due to the value added by the value adding module.

5. The computer-implemented system of claim 4 wherein the value added by the value adding module is cash provided by the third party.

6. The computer-implemented system of claim 4 wherein the third party is a manufacturer of the used equipment.

7. The computer-implemented system of claim 4 wherein the third party is a manufacturer of equipment, wherein the manufacturer provides the value to sell the used equipment despite the used equipment having been manufactured by a company other than the manufacturer.

8. The computer-implemented system of claim 7 wherein the company that manufactured the used equipment is a competitor of the manufacturer that is providing the value to sell the used equipment.

9. The computer-implemented system of claim 4 wherein the third party is a dealer of the used equipment.

10. The computer-implemented system of claim 1 wherein a dealer of equipment and a manufacturer of equipment both contribute resources to provide approximately the value determined by the value adding module.

11. The computer-implemented system of claim 1 wherein the value adding module examines a plurality of value adding items to determine which of the value adding items are to be used as the value to be added by the third party, wherein the value adding module determines that at least two of the value adding items are to be used as the value to be added by the third party.

12. The computer-implemented system of claim 1 wherein the third party adjusts the value determined by the value adding module.

13. The computer-implemented system of claim 1 wherein the value adding module examines a plurality of value adding items to determine which of the value adding items are to be used as the value to be added by the third party.

14. The computer-implemented system of claim 13 wherein the value adding module examines historical data associated with the used equipment to determine which of the value adding items are to be used as the value to be added by the third party.

15. The computer-implemented system of claim 14 wherein the historical data includes the historical servicing data associated with the used equipment.

16. The computer-implemented system of claim 15 wherein future servicing data associated with the used equipment is used to determine which of the value adding items are to be used as the value to be added by the third party.

17. The computer-implemented system of claim 1 wherein the value adding module examines a plurality of value adding items to determine which of the value adding items are to be used as the value to be added by the third party, wherein the determined value is an optimal value that provides the least financial detriment to the third party.

18. The computer-implemented system of claim 17 wherein the plurality of value adding items are items selected from the group consisting of equipment inspection, equipment repair, equipment certification, extended warranty offer, equipment upgrade, routine maintenance, financial benefits, shipping benefits, and combinations thereof.

19. The computer-implemented system of claim 17 wherein the value adding module retrieves from the used equipment brokering database data related to the used equipment in order to determine which of the value adding items are to be used as the value to be added by the third party.

20. The computer-implemented system of claim 19 wherein the value adding module retrieves data related to the used equipment from computers located remotely on a network, said value adding module using the retrieved data to determine which of the value adding items are to be used as the value to be added by the third party.

21. The computer-implemented system of claim 20 wherein the network is an Internet network.

22. The computer-implemented system of claim 20 wherein the retrieved data from the remotely located computers are data selected from the group consisting of warranty data from a manufacturer, financial data from a financial institution, transportation data from a shipping company, and combinations thereof.

23. The computer-implemented system of claim 20 wherein computers of different shipping companies transmit shipping data for use by the value adding module, wherein the value adding module determines which shipping company to use based upon the transmitted shipping data.

24. The computer-implemented system of claim 20 wherein computers of different financial companies transmit financial data for use by the value adding module, wherein the value adding module determines which financial company to use to finance the selling of the used equipment based upon the transmitted financial data.

25. The computer-implemented system of claim 1 wherein the selling criteria data includes an asking price at which the seller will sell the used equipment, wherein the asking price provided by the seller specifies that a market value is to be used as the asking price.

26. The computer-implemented system of claim 25 wherein the market value is a blue book price for the used equipment.

27. The computer-implemented system of claim 25 wherein the value adding module receives market value data from a computer located remotely on a network.

28. The computer-implemented system of claim 27 wherein the network is an Internet network.

29. The computer-implemented system of claim 25 wherein at a first date the value adding module uses as the asking price a first market value obtained from a computer located remotely on a network, wherein the first market value is indicative of market value of the used equipment on the first date,
wherein at a second date the value adding module retrieves from a computer located remotely on the network a second market value for use as the asking price, wherein the second market value is indicative of market value of the used equipment on the second date.

30. The computer-implemented system of claim 29 wherein the network is an Internet network.

31. The computer-implemented system of claim 25 wherein the value adding module receives market value data from a plurality of computers located remotely on a network, wherein the value adding module performs a statistical function to determine a single market value for use as the asking price.

32. The computer-implemented system of claim 31 wherein the statistical function is an averaging function.

33. The computer-implemented system of claim 1 wherein the selling criteria data are data selected from the group consisting of equipment make, model, years, hours, condition, optional equipment, features, size, location, capacity, digital photo, warranty data, and combinations thereof.

34. The computer-implemented system of claim 1 wherein the buyer provides search criteria to locate suitable used equipment within the used equipment brokering database.

35. The computer-implemented system of claim 34 wherein the buyer's search criteria includes criteria selected from the group consisting of equipment make criteria, model criteria, years criteria, hours criteria, condition criteria, optional equipment criteria, features criteria, size criteria, location criteria, capacity criteria, warranty data criteria, search criteria deviations, and combinations thereof.

36. The computer-implemented system of claim 35 wherein the used equipment matching database engine provides to the buyer used equipment data entries from the used equipment brokering database that exactly match the buyer's search criteria.

37. The computer-implemented system of claim 36 wherein the selling criteria data includes an asking price at which the seller will sell the used equipment, wherein the used equipment matching database engine provides to the buyer used equipment data entries from the used equipment brokering database that do not exactly match the buyer's search criteria, but that substantially satisfies the asking price due to the added value.

38. The computer-implemented system of claim 1 wherein the used equipment brokering database includes data structures selected from the group consisting of equipment information data structure means, value adding data structure means, pricing information data structure means, service information data structure means, and combinations thereof.

39. The computer-implemented system of claim 1 wherein the seller is a dealer of used equipment.

40. The computer-implemented system of claim 1 wherein a dealer of used equipment transmits to the used equipment matching database engine additional information regarding the used equipment.

41. The computer-implemented system of claim 40 wherein the dealer provides the additional information when the used equipment is being serviced by the dealer for the seller.

42. The computer-implemented system of claim 41 wherein the additional information contains what servicing is being performed by the dealer to the used equipment.

43. The computer-implemented system of claim 1 wherein a wireless communication system is used to transmit operational data about the used equipment for storage in the used equipment brokering database.

44. The computer-implemented system of claim 43 wherein the operational data is transmitted after the used equipment has been operational for a predetermined time.

45. The computer-implemented system of claim 1 wherein an Internet network provides data communication among the buyer, the seller, and the used equipment matching database engine.

46. The computer-implemented system of claim 1 wherein the used equipment matching database engine generates an agreement that is used to implement the added value.

47. The computer-implemented system of claim 46 wherein the agreement is a shipping agreement.

48. The computer-implemented system of claim 46 wherein the agreement is a financial arrangement agreement.

49. A computer-implemented method for matching buyers with sellers over a network in order to sell used equipment, comprising the steps of:
(a) receiving over the network from a seller used equipment selling data which includes an asking price for selling the seller's used equipment;
(b) storing the used equipment selling data in an used equipment brokering database, said used equipment brokering database including at least one data entry for each piece of used equipment;
(c) receiving over the network from a buyer used equipment search criteria;
(d) receiving over the network from the buyer a bid price for used equipment;
(e) using a value adding software module to determine at least one equipment data entry whose associated asking price differs from the buyer's bid price;
(f) determining value to be added to the used equipment data entry determined in step (e) such that the bid price substantially satisfies the seller's asking price; and
(g) providing to the buyer as a purchase option the used equipment data entry for which the value was determined in step (f).
